(19) United States
(12) Patent Application Publication
(10) Pub. No.: US 2015/0336065 A1
(43) Pub. Date: Nov. 26, 2015

(54) SYSTEMS AND METHODS FOR TRANSLATING, LEVITATING, AND OR TREATING OBJECTS IN A RESONATING CHAMBER

(71) Applicant: BURST ENERGIES, INC., Dover, DE (US)

(72) Inventor: Yuri PISHCHALNIKOV, Grass Valley, CA (US)

(21) Appl. No.: 14/442,720

(22) PCT Filed: Nov. 12, 2013
(86) PCT No.: PCT/US13/69763

§ 371 Date: May 13, 2015

Related U.S. Application Data
(60) Provisional application No. 61/725,974, filed on Nov. 13, 2012.

(51) Int. Cl. B01J 8/16; B01J 19/10; B65G 53/58; B01J 19/00

(52) U.S. Cl. CPC B01J 8/16; B01J 19/008; B01J 19/10; B65G 53/58; B01J 2208/00805; B01J 2219/0879

(57) ABSTRACT

A process for translating objects a resonating chamber is described. The process includes: (i) obtaining a resonating chamber filled with a fluid medium and objects disposed therein; and (ii) generating one or more different standing waves to convey said objects from their disposed position to another location inside the resonating chamber. Using the above-described translating process, the objects may be positioned at a cavitation zone inside the resonating chamber. In one aspect of the present teachings, the objects are then subject to acoustic cavitation to convert at least some of the objects from one state to another state.

### RELATED APPLICATION

This application claims priority from U.S. Provisional Application No. 61/725,974, filed on Nov. 13, 2012, which is incorporated herein for all purposes.

### FIELD

The present invention relates generally to systems and methods for any one of translating, levitating, and treating objects in a resonating chamber. More particularly, the present invention relates to systems and methods for any one of translating, levitating, and treating objects in a resonating chamber using acoustic energy.

### BACKGROUND

Acoustic reactors and resonating chambers process different types of objects, such as coating materials and hollow spheres, to provide different types of products. In other circumstances, these reactors and chambers might process test materials to ensure the proper working or implementation of the reactors, chambers and/or test materials. During processing and or testing, however, it is often desirable to position these objects and test materials at a particular location inside the reactors and/or chambers. In other instances, it may be desirable to remove the objects and test materials from within the reactors and/or chambers. Unfortunately, the steps of inserting, moving and holding objects inside the reactors and/or chambers disrupts an acoustic field that is present inside the operating reactors and/or chambers during their operative state. Moreover, in some instances where the reactors and/or chambers are typically filled with a medium, which facilitates delivery of acoustic energy inside the reactors and/or chambers, it is simply not possible or practical to accomplish such tasks.

### SUMMARY

In one aspect, the present teachings disclose a process for translating objects in a resonating chamber. The process includes: (i) obtaining a resonating chamber filled with a fluid medium and having objects disposed therein, and the resonating chamber having coupled thereto one or more transducers; (ii) generating a first standing wave, using one or more of the transducers, through the fluid medium, such that at least one of a first high pressure location and/or at least one of a first zero pressure location associated with the first standing wave is distributed inside the resonating chamber, and at least some of the objects are positioned at either at least one first high pressure location and/or at least one first zero pressure location; (iii) ceasing the generating of the first standing wave; and (iv) generating a second standing wave, using one or more of the transducers, through the fluid medium, such that at least one of a second high pressure location and/or at least one of a second zero pressure location associated with the second standing wave is distributed inside the resonating chamber, and at least some of the objects are translated from at least on first high pressure location to at least one second high pressure location and/or are translated from at least one first zero pressure location to at least one second zero pressure location.

In another aspect of the present teachings, the first high pressure location includes a location within the resonating chamber that is occupied by a first high pressure antinode obtained from generating the first standing wave, the first zero pressure location includes a location within the resonating chamber that is occupied by a first zero pressure node obtained from generating the first standing wave, the second high pressure location includes a location within the resonating chamber that is occupied by a second high pressure antinode obtained from generating the second standing wave, and the second zero pressure location includes a location within the resonating chamber that is occupied by a second zero pressure node obtained from generating the second standing wave. In this aspect, during generating the first standing wave or generating the second standing wave, the objects that are less dense than the fluid medium accumulate at the first high pressure antinode and/or the second high pressure antinode, and the objects that are more dense than the fluid medium accumulate at the first zero pressure node and/or at the second zero pressure node.

According to certain embodiments of the present teachings, generating the first standing wave includes generating a translating wave and generating the second wave includes generating a centering wave, such that generating the translating wave is carried out prior to generating centering wave, generating the translating wave causes at least some of the objects to be translated to the first high pressure locations or the first zero pressure locations that are a distance away from a center region of the resonating chamber, and wherein generating the centering waves causes the second high pressure locations and/or the second zero pressure locations to be disposed at or near the center region of the resonating chamber. In this embodiment, generating the centering wave causes at least some of the objects to be translated from the first high pressure location or the first zero pressure location to a location at or near the center region of the resonating chamber. During generating the centering wave, at least some of the objects may accumulate in a disk-like formation at or near the center region of the resonating chamber.

Generating the centering wave may be carried out at a resonant frequency such that the second zero pressure locations and the second high pressure locations are not spherically aligned inside the resonating chamber. Generating the first standing wave may be produced in a spherical mode at a resonant frequency such that the first zero pressure locations and the first high pressure locations are spherically aligned inside the resonating chamber, and generating the second standing wave may be produced in a non-spherical mode at another resonant frequency such that the second zero pressure locations and the second high pressure locations are not spherically aligned inside the resonating chamber.

According to certain embodiments of the present teaching, prior to generating a first standing wave, the objects are resting on a bottom region or on a top region of the resonating chamber, and prior to ceasing generating the first standing wave, at least some of the objects are levitating at a high pressure location or at a zero pressure location associated with the first standing wave. The second high pressure location may be closer in distance to the center region of the resonating chamber than the first high pressure location, and/or the second zero pressure location is closer in distance to the center region of the resonating chamber than the first zero pressure location. In certain embodiment of the present teachings, prior to generating a first standing wave, the objects are disposed at a top region of the resonating chamber, and prior to ceasing the generating of the first standing wave, at least some of the objects are levitating at a high pressure location associated with the first standing wave.

In another aspect, the present teachings disclose a process for treating objects in a treatment zone inside a resonating chamber. The process includes: (i) obtaining a resonating chamber filled with a fluid medium and objects disposed therein; (ii) generating multiple different standing waves to translate the objects from a position inside the resonating chamber, through the fluid medium, to a treatment zone inside the resonating chamber; and (iii) treating the objects at or near the treatment zone of the resonating chamber to transform some of the objects from a first state to a second state.

In certain embodiments of the present teachings, the first state includes at least some objects that are not cavitated, and the second state includes at least some objects that are cavitated. In other certain embodiments of the present teachings, treating includes cavitation, and the treatment zone includes a cavitation zone wherein a last one of the multiple different standing waves is a positioning wave that positions some of the objects at or near the treatment zone, which is preferably at or near a center region of the resonating chamber. In such embodiments, prior to treating the objects, generating multiple different standing waves may include generating a centering wave that causes a zero pressure location to be disposed at or near a center region of the resonating chamber and causes the objects to be translated to the center region. Generating at least one of the positioning waves may be produced in a non-spherical mode at a resonant frequency. According to one embodiment of the present teachings, the process further includes generating at least one positioning wave to position the objects, at least some of which are in the first state, at the treatment zone of the resonating chamber. By way of example, in this embodiment, some implementations include a further step of, after generating at least one positioning wave, treating for a second time some of the objects.

In certain preferred embodiments of the present teaching, generating multiple different standing waves includes: (i) generating a first positioning wave through the fluid medium, such that at least one of a first high pressure location and/or at least one of a first zero pressure location associated with the first positioning wave is distributed inside the resonating chamber, and at least some of the objects are positioned at either of at least one first high pressure location and/or at least one first zero pressure location; (ii) ceasing the generating of a first positioning wave; (iii) generating a second positioning wave through the fluid medium, such that at least one of a second high pressure location and/or at least one of a second zero pressure location associated with the second positioning wave is distributed inside the resonating chamber, at least some of the objects are translated from at least one of a first high pressure location and/or at least one of a first zero pressure location associated with the first positioning wave at least one of a second high pressure location and/or at least one of a second zero pressure location associated with the second positioning wave. In some embodiments of the present teachings, the process further includes performing one or more positioning and treating cycles after the treating, wherein one of the positioning and treating cycles comprises positioning some of the objects to the treatment zone and treating some of the objects for another time.

In yet another aspect, the present teachings disclose a system for treating objects The system includes: (i) a fluid medium; (ii) a resonating chamber filled with the fluid medium; (iii) objects at a levitated state at or near a cavitation zone of the resonating chamber; and (iv) one or more transducers coupled to the resonating chamber, wherein one or more of the transducers produce a treatment frequency that facilitates treatment of at least some of the objects at the treatment zone to transform at least some of the objects from one state to another state. Preferably, resonating chamber is configured in a shape that is one member selected from a group comprising a sphere, a cube, a parallelepiped, and a cylinder. In certain embodiments of the present teachings, objects are graphite particles, preferably some of which transform to diamonds due to cavitation of at least some of the objects at the cavitation zone.

The construction and method of operation of the invention, however, together with additional objects and advantages thereof will be best understood from the following descriptions of specific embodiments when read in connection with the accompanying figures.

### BRIEF DESCRIPTION OF THE DRAWINGS

FIG. 1 shows a side-sectional view of a resonator system, according to one embodiment of the present arrangements that includes an exemplar resonating chamber for subjecting objects to acoustic energy.

FIG. 2A shows a side-sectional view of the resonating chamber of FIG. 1 that includes a profile, according to one embodiment of the present arrangements, of a first standing wave generated by a first resonant frequency, which translates objects from a bottom region of the chamber to a first location inside the chamber.

FIG. 2B shows a side-sectional view of the chamber and the first standing wave profile, as shown in FIG. 2A, and a second standing wave generated by a second resonant frequency, which translates objects from the first location to a second location inside the chamber.

FIG. 2C shows a side-sectional view of the chamber and the first and the second standing wave profiles, as shown in FIGS. 2A and 2B, and a third standing wave generated by a third resonant frequency, which translates objects from the second location to a third location inside the chamber.

FIG. 2D shows a side-sectional view of the chamber and the first, the second and the third standing wave profiles, as shown in FIGS. 2A, 2B and 2C, and a fourth, a fifth, a sixth and a seventh standing waves, each generated by a corresponding fourth, fifth, sixth and seventh resonant frequencies, which translates objects from location to location inside the chamber until the objects are positioned at a treatment zone, e.g., a cavitation zone located at a center region of the chamber.

FIG. 3 is a computer screen display, according to one embodiment of the present arrangements, for displaying and adjusting standing wave parameter settings used for effective translation and/or cavitation of objects inside a resonating chamber.

FIG. 4A shows a flowchart of a process, according to one embodiment of the present teachings, for propelling objects to a location in a resonating chamber.

FIG. 4B shows a series of frames from a video, according to one embodiment of the present teachings, illustrating displacement of objects, such as graphite particles, from one location to another in a resonating chamber.

FIG. 5A shows a flowchart for a process, according to another embodiment of the present teachings, for cavitating objects in a resonating chamber.

FIG. 5B shows a series of frames from a video, according to one embodiment of the present arrangements, showing objects, such as graphite particles, subject to multiple cycles of cavitation.

FIG. 6 shows a series of frames from another video, according to one embodiment of the present arrangements, detailing the behavior of objects of a particular type when they are subject to a single cavitation cycle.

FIG. 7A is a picture of a side view of graphite particles that are arranged in a disk-like configuration, according to one embodiment of the present teachings, and levitating at cavitation zone of a resonating chamber.

FIG. 7B is a picture of a front view of the graphite particles shown in FIG. 7A.

FIG. 7C is a picture of a side view of graphite chunks that are arranged in a disk-like configuration, according to one embodiment of the present teachings, and levitating at a center region of a resonating chamber.

### DETAILED DESCRIPTION OF THE PREFERRED EMBODIMENTS

In the following description numerous specific details are set forth in order to provide an understanding of the present invention. It will be apparent, however, to one skilled in the art that the present invention may be practiced without limitation to some or all of these specific details. In other instances, well known process steps have not been described in detail in order to not unnecessarily obscure the invention.

The present teachings address the challenges posed during translation of objects in acoustic reactors or resonating chambers by recognizing that any object positioned in a fluid (e.g., liquid or gas) experiences a force exerted by the surrounding fluid. Moreover, the force is proportional to the pressure gradient in the fluid. An acoustic wave may produce the requisite pressure gradient and the resulting force (from the gradient) is called an acoustic radiation force. Although both propagating and standing waves produce radiation pressure that may be potentially used to displace or translate objects in a fluid, the present teachings recognize that the radiation forces produced by standing waves are relatively stronger. Use of standing waves, however, requires meeting a different set of challenges. By way of example, the present teachings recognize that movement of objects, using an acoustic standing wave, to a nearest pressure node or antinode may be limited to a distance that is about half of a wavelength of the acoustic wave. The present teachings solve these and other challenges posed by the use of standing waves, by providing systems and methods for translating and/or levitating objects by standing waves in acoustic reactors and resonating chambers.

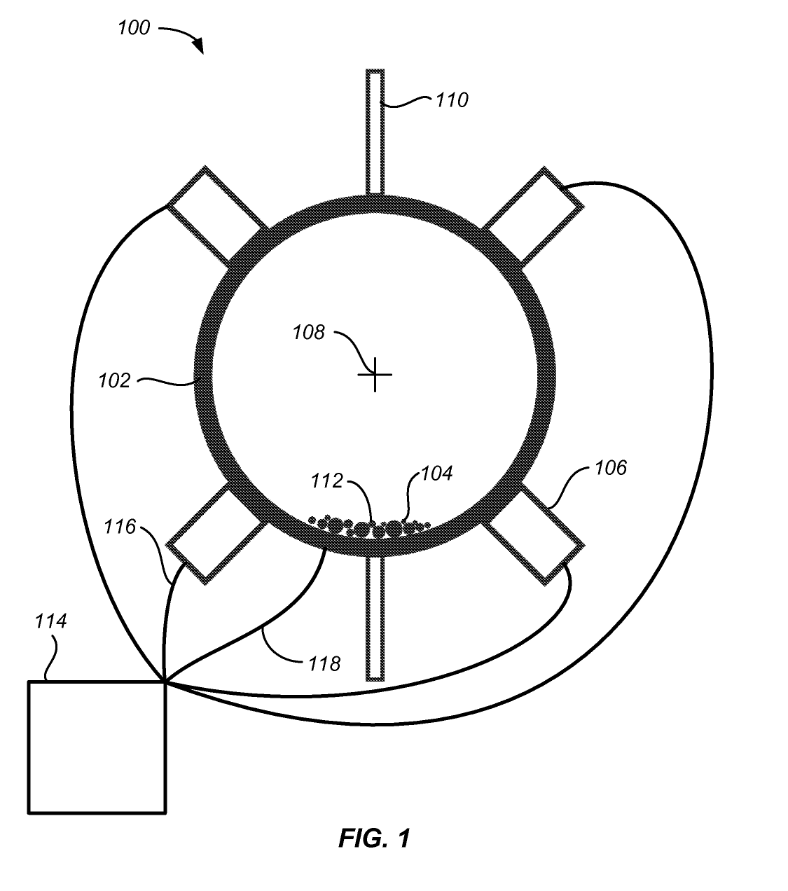

FIG. 1 shows a side-sectional view of a resonator system 100, according to one embodiment of the present arrangements, for any one of levitating, translating, and/or treating (e.g., cavitating) test objects using acoustic wave energy. Resonator system 100 includes a chamber 102 that is fitted with one or more acoustic drivers 106 on its outer sidewalls, and has one or more ports 110 connected to it at each end, as shown in FIG. 1. A control system 114 is connected to resonator system 100 via couplings 116 and 118, which connect control system 114 to one or more transducers 106 and chamber 102, respectively.

Chamber 102 includes a bottom region 112 (i.e., located at a bottom portion of chamber 102) and a center region 108 (i.e., located at or near a center portion of chamber 102). To deliver acoustic energy therethrough, chamber 102 is filled with a fluid medium, e.g., liquid or gas (not shown to simplify illustration). Inside chamber 102, objects 104 rest at bottom region 112 and/or may be suspended at the top region or throughout the fluid medium.

During an operative state of resonator system 100, acoustic drivers 106, preferably controlled by control system 114, deliver acoustic energy through fluid medium inside chamber 102. In one embodiment of the present arrangements, an acoustic standing wave is created in chamber 102 such that the acoustic field generated is sufficiently high to overcome gravitation and/or buoyancy forces. The acoustic standing wave positions or propels objects 104 to or at a specific location or region inside chamber 102. Thus, the present arrangements provide the advantage of translating and levitating objects (that would otherwise sink to the bottom or float to the top of chamber 102) inside a fluid-filled chamber, without inserting an external device or using a mechanism to touch or otherwise mechanically disturb objects 104. The present arrangements also prevent disruption of an acoustic field present in chamber 102. Moreover, in certain embodiments of the present arrangement, objects 104 are positioned at a cavitation zone, preferably at or near center region 108, where acoustic cavitation energy may be localized and applied. According to the present teachings, acoustic energy is applied to create different types of standing waves. The standing waves may accomplish any one of translating, levitating, and treatment of objects 104 inside chamber 102. A standing wave that translates objects 104 is herein referred to as a “translating wave.” A standing wave that levitates objects 104 is herein referred to as a “levitating wave.” A standing wave that treats objects 104 is herein referred to as a “treatment wave,” and in those embodiments where the treatment is cavitation of the objects, then the “treatment wave” is herein referred to as a “cavitating wave.”

Chamber 102 is a shell body made of any material that defines an inner volume within which a fluid medium is confined. Chamber 102 facilitates delivery of acoustic energy therethrough with sufficient intensity to translate, levitate, and/or to cavitate objects 104 therein. As a result, the fluid medium includes any liquid or gas capable of transmitting acoustic energy. In one preferred embodiment of the present arrangements, the fluid medium is water. A shape of chamber 102 is preferably one member selected from a group comprising a cube, a cylinder, a parallelepid, and a sphere. Preferably, however, chamber 102 is a sphere-shaped object, and is comprised of any rigid material, such as glass, plastic, metal, elastic material, and composites thereof.

One or more transducers 106 (e.g., piezo-acoustic transducers) are designed to impart acoustic energy to a fluid-filled chamber 102. The acoustic energy may be in the form of sound or ultrasound. In one preferred embodiment of the present arrangements, the acoustic energy is generated as acoustic pulses. Although FIG. 1 shows one or more transducers 106 positioned outside the sidewalls of chamber 102, the present teachings recognize that one or more transducers may be disposed within chamber 102. Regardless of the positioning of transducers 106, they are designed to deliver enough acoustic energy to translate, levitate, and/or treat (e.g., cavitate) objects 104 inside chamber 102. In certain embodiments of the present arrangements, a frequency used to translate, levitate, and/or treat objects 104 inside chamber 102 is determined based on one or more members selected from a group comprising a resonating chamber size, a resonating chamber shape, size of objects, mass of objects, properties of a fluid medium inside a resonating chamber (including fluid temperature), and a desired process (e.g., translating, levitating, and/or treating). As explained below, in certain preferred aspects of the present arrangements, enough acoustic energy is provided at a center region 108 to cavitate objects 104.

One or more ports 110 are disposed on or through chamber 102 for introducing the fluid medium and objects 104 therein. In other embodiments ports 110 are not necessary and other means may be used to introduce fluid medium and/or objects 104 inside a chamber 102. In certain aspects of the present arrangements, ports 110 are used for pressurizing and/or degassing chamber 102.

According to one embodiment of the present arrangements, a control system 114 is used to control various components of resonator system 100. Control system 114 may include any one of a computer, a function generator, and an amplifier. According to one embodiment of the present arrangements, a computer requests a frequency of a certain duration and a certain amplitude for generating a standing wave that is present in a fluid-filled chamber. The function generator creates a sinusoidal wave at the requested frequency, duration, and amplitude, typically limited to that produced by about 10V. The amplifier amplifies the amplitude of the standing wave, typically up to about several-hundred volts, and the standing wave is present in a fluid-filled chamber 102.

Control system 114 may be used to control the delivery of acoustic energy to resonator system 100 via coupling 116 to one or more transducers 106. Control system 114, via one or more couplings 118, may be similarly used for monitoring the interior conditions (e.g., temperature, pressure, amount of objects 104 at a particular location) of chamber 102, and adjusting settings based on those conditions. Control system 114 may also be used to monitor the amount or amounts of objects at a particular location in a resonator shell, or the amount of processing (e.g., cavitation) that has occurred. To facilitate any one of these functions, the computer of control system 114 preferably includes a memory, a processor, an input device (e.g. keyboard), a user interface, and software. Examples of functions that the software may be used for include controlling frequencies settings, controlling amplitude settings, setting on times, setting off times, activating or deactivating one more transducers 106, as well as other factors associated with delivery of acoustic energy to resonator system 100.

Objects 104 are any objects or particles that may be any of translated, levitated, and cavitated, using resonator system 100. Objects 104 may be any one member chosen from a group comprising particles, sediments, powders, fibers buoyant voids, and droplets of other fluids. In those instances where particles are used as objects 104, such particles may have a longest dimension that is less than half the wavelength of a standing wave that acts upon it. Although objects 104 may typically consist of a relatively homogenous mixture (e.g., one that primarily includes graphite particles), more than one type of object may be handled at one time inside resonator system 100.

The present teachings recognize that those objects 104 that are more dense and less compressible than a fluid medium in which they are disposed (i.e., relatively more dense than the fluid medium), accumulate at low pressure or zero pressure locations inside chamber 102. The present teachings also recognize that, on the other hand, those objects 104 that are less dense and more compressible than the fluid medium in which they are disposed (i.e., relatively less dense than the fluid medium) accumulate at high pressure locations inside chamber 102. In preferred embodiments of the present arrangements, zero pressure locations and high pressure locations associated with a standing wave are zero pressure nodes and high pressure antinodes, respectively, of that standing wave.

In a non-operative state of resonator system 100, objects 104 that are relatively dense (relative to the fluid medium), such as graphite particles in water, are typically resting on bottom region 112 in large part due to a gravitational force acting on objects 104. In the same non-operative state of resonator 100, objects 104 that are relatively less dense (relative to the fluid medium), such as bubbles in water, are typically drawn to a top region (which is opposite to bottom region 112) of chamber 102. The location of objects 104 inside resonating chamber 102, therefore, depends on the relative density of objects 104 with respect to the density of the fluid medium.

As will be explained further below, in an operative state of resonator system 100, a series of acoustic standing waves generated, in sequence, by producing resonant frequencies at different instances in time, is used to incrementally translate and/or levitate objects 104 to or at a specific location or region within chamber 102. By way of example, relatively dense objects 104 will accumulate at one or more zero pressure nodes associated with an acoustic standing wave generated by transducers 106, and relatively less dense objects 104 will accumulate at one or more high pressure antinodes associated with an acoustic standing wave generated by transducers 106. When generating a resonant frequency associated with a particular acoustic standing wave is stopped, and a different resonant frequency associated with a different acoustic standing wave is generated, at least some of objects 104 will be propelled to a different zero pressure node or a different high pressure antinode, preferably at a different location, that is associated with the different acoustic standing wave. In such manner, objects 104 inside fluid-filled chamber 102 are maintained at or propelled to a particular location in the chamber, according to the present teachings.

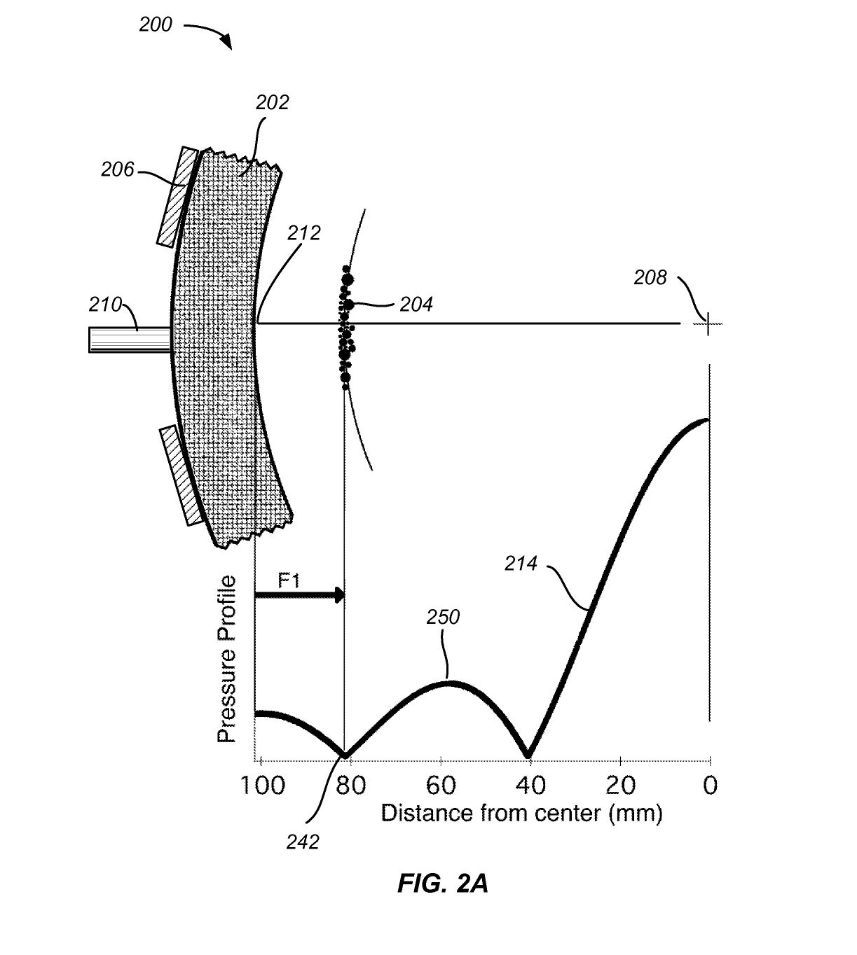

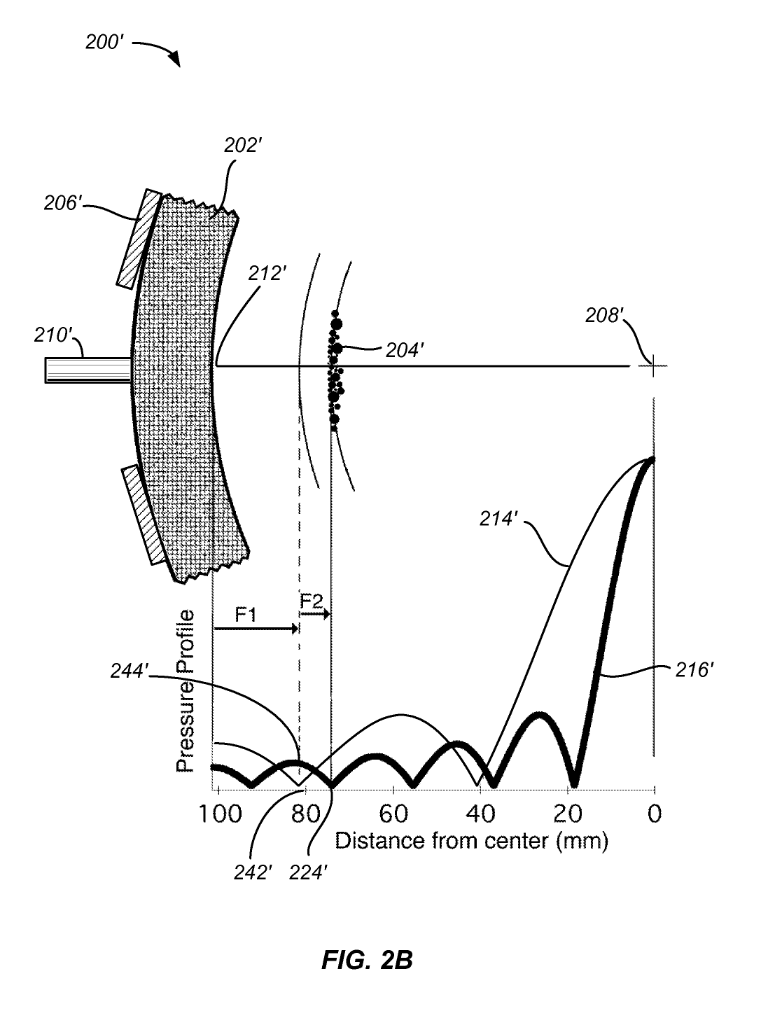

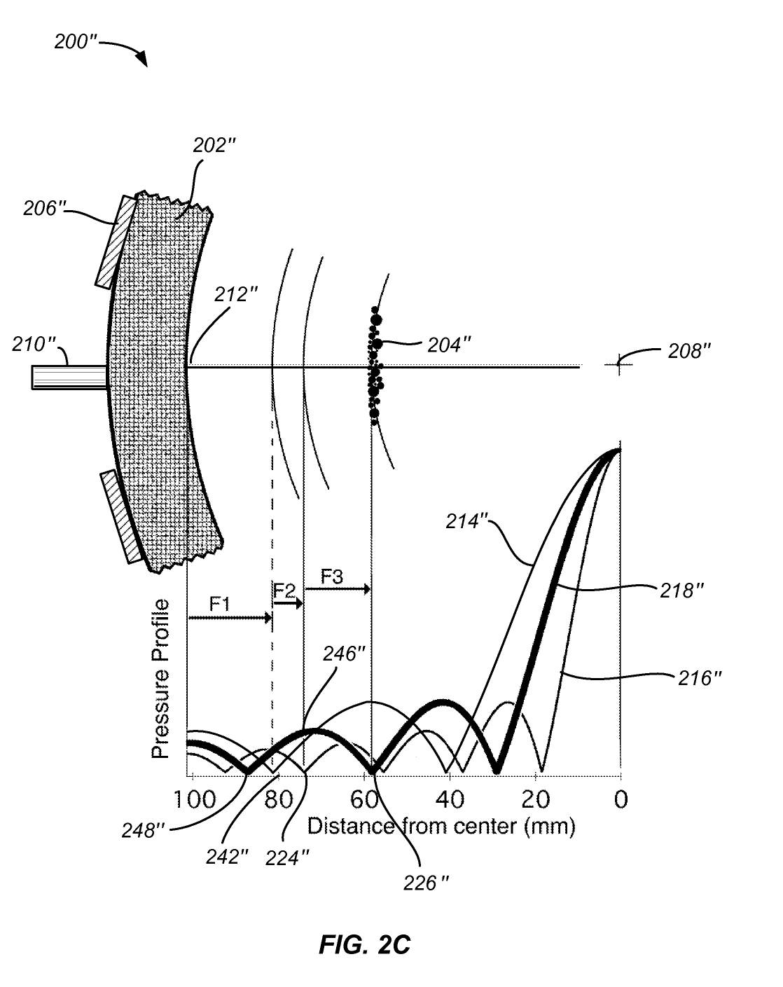

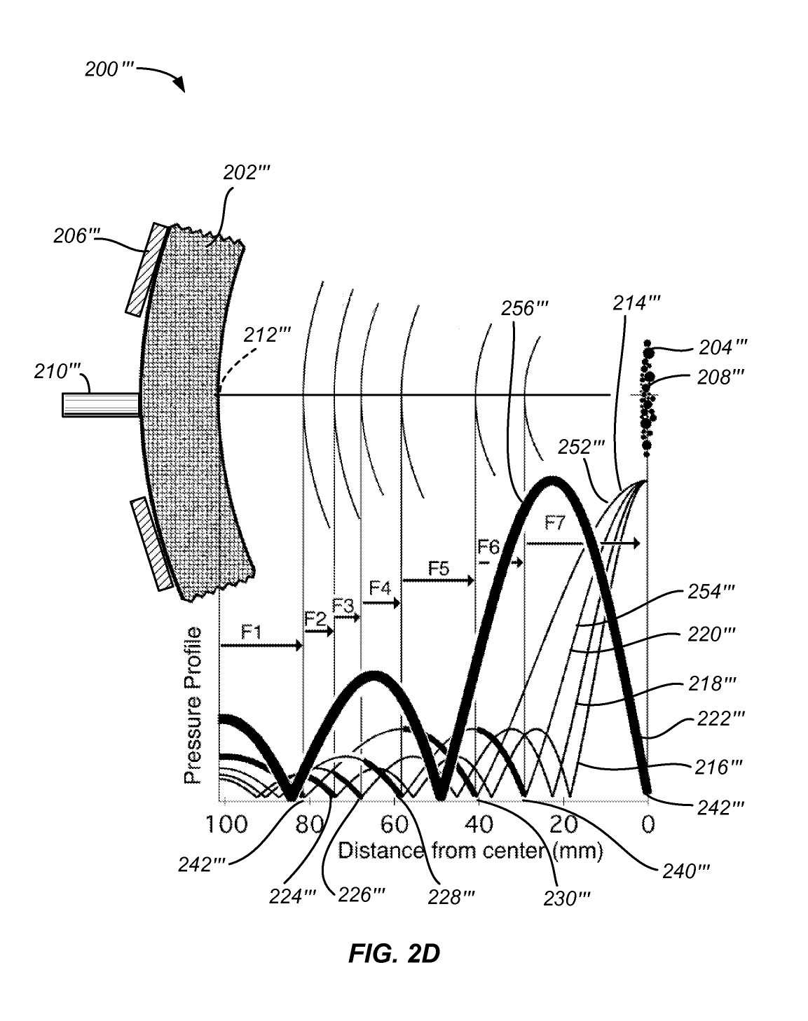

FIGS. 2A-2D collectively show that by applying a sequence of standing waves, each generated by a particular resonant frequency, objects move from one location to another location inside a resonating chamber. To this end and as an example, seven sequentially applied frequencies, F1-F7, incrementally propel objects from a bottom region to a center region of the resonating chamber. According to the embodiments of FIGS. 2A-2D, objects (e.g., graphite particles) are more dense than the fluid medium (e.g., water) disposed inside the resonating chamber.

FIG. 2A shows a profile 200, according to one embodiment of the present arrangements, of a standing wave 214 inside chamber 202 (shown as a side-sectional view). A chamber 202, acoustic transducers 206, a port 210, a bottom region 212, and a center region 208, are substantially similar to their counterparts shown in FIG. 1 (i.e., chamber 102, one or more acoustic transducers 106, at least one port 110, bottom region 112, and center region 108).

One or more transducers 106 produce a resonant frequency, F1, resulting in standing wave 214. FIG. 2A shows a radial distance (in millimeters) from a center region 208 to bottom region 212, plotted along an x-axis, and a pressure amplitude of standing wave 214 plotted along y-axis. The present teachings recognize that as the amplitude of standing wave 214 rises or drops, the pressure produced from the standing wave also correspondingly rises or drops. As a result, y-axis is also labeled as “Pressure Profile,” and standing wave 214 has both zero pressure nodes and high pressure antinodes. According to FIG. 2A, standing wave 214 creates two zero pressure nodes, i.e., a node 242 located about 80 mm away from center region 208, and another node located about 40 mm away from center region 208. Similarly, standing wave creates at least two high pressure antinodes, i.e., one antinode at about 60 mm away from bottom region 208, and another high pressure antinode at center region 208.

When standing wave 214 is generated objects 204 are propelled from bottom region 212 (e.g., as shown by objects 104 resting on bottom region 112 of FIG. 1) to zero pressure node 242, as shown in FIG. 2A. The arrow adjacent to “F1” represents a distance traveled by objects 204. In one embodiment of the present teachings, objects 204 may be thought of as being propelled “downhill” along a portion of standing wave 214 to the nearest zero pressure node. “Downhill” in this instance refers to a downward slope in the pressure profile that extends from bottom region 212 to zero pressure node 242.

In the embodiment of FIG. 2A, the acoustic field of frequency F1 is symmetrically distributed inside chamber 202. In other words, zero pressure nodes 242 and high pressure nodes 250 are spherically arranged about center region 208 inside chamber 202. Thus, the frequency producing such zero pressure and high pressure nodes is regarded as operating in a “spherical mode.” In other embodiments of the present arrangements, however, an acoustic field inside chamber 202 may be non-symmetrically distributed inside chamber 202 such that the zero pressure nodes and high pressure antinodes are not spherically arranged about center region 208 inside chamber 202. Such non-spherically distributed acoustic fields are referred to as “non-spherical modes.” In accordance with preferred embodiments of the present teachings, spherical modes are used because they produce structurally simpler, more predictably positioned, and relatively easily controlled standing waves than those produced by non-spherical modes. Accordingly, using spherical modes provides an advantage of better control over translation and levitation of particles inside a resonating chamber. In certain embodiments of the present arrangements, however, a non-spherical mode is preferably used (e.g., to propel relatively dense particles to a center region of a chamber by creating a zero pressure node at the center region).

FIG. 2B shows another profile 200′, according to one embodiment of the present arrangements, of a standing wave 214′ generated by a spherical mode at frequency F1, and a standing wave 216′ generated by a spherical mode at frequency F2 (that is different from frequency F1). It is noteworthy that in preferred embodiments of the present teachings, frequency F2 is generated after ceasing generation of frequency F1. According to these embodiments of the present teachings, a single resonating frequency or a standing wave associated therewith is generated one instance at a time inside a resonating chamber.

In FIG. 2B, like standing wave 214′ (which is substantially similar to standing wave 214 of FIG. 2A), standing wave 216′ is also present inside chamber 202′ (shown as a side-sectional view). Objects 204′, chamber 202′, acoustic transducers 206′, a port 210′, standing wave 214′, a bottom region 212′, a center region 208′, as well as the x-axis and y-axis shown in FIG. 2B, are substantially similar to their counterparts shown in FIG. 2A (i.e., objects 204, chamber 202, acoustic transducers 206, port 210, standing wave 214, bottom region 212, center region 208, as well as the x-axis and y-axis shown in FIG. 2B).

Inside chamber 202′, spherical mode at frequency F2 creates one or more zero pressure nodes and one or more high pressure antinodes at locations that are different from those where zero pressure nodes and high pressure antinodes are created by spherical mode at frequency F1. Further, at least one of the zero pressure nodes 224′, i.e., zero pressure node denoted by reference numeral 224′, associated with frequency F2, is proximate and the closest to zero pressure node 242′ (which is substantially similar to zero pressure node 242 associated with frequency F1 and shown in FIG. 2A). Zero pressure node 224′ is also closer to center region 208′ than zero pressure node 242′.

FIG. 2B also shows that at the initial stages of when frequency F2 is generated, particles located at zero pressure node 242′, associated with frequency F1, are present at or near an antinode location 244′ of frequency F2. The location of zero pressure node 242′ associated with frequency F1 is the same as or near a location 244′ associated with frequency F2. Further, location 244′ is not a zero pressure node associated with frequency F2.

Frequency F2 propels objects 204′ from location 242′ to a next zero pressure node 224′. Objects 204′ travel a distance shown by arrow adjacent to “F2” and move closer to center region 208′. Moreover, as object 204′ are so propelled, they experience a pressure drop (shown by a downhill pressure profile that extends from antinode 244′ to zero pressure node 224′ associated with frequency F2).

FIG. 2C shows a profile 200″, according to one embodiment of the present arrangements, of a standing wave 214″ generated by a spherical mode frequency F1, a standing wave 216″ generated by a spherical mode frequency F2, and a standing wave 218″ generated by a spherical mode frequency F3. Objects 204″, a chamber 202″, acoustic transducers 206″, a port 210″, a center region 208″, a bottom region 212,″ standing wave 214″, standing wave 216,″ and a zero pressure node 224,″ as well as the x-axis and y-axis shown in FIG. 2C, are the same as or substantially similar to their counterparts in FIGS. 2A and 2B.

As shown in FIG. 2C, immediately after ceasing generation of standing wave 216″, when standing wave 218″ is generated at a frequency F3, objects 204″ are propelled from a location of antinode 246″ to a location of zero pressure node 226″ associated with frequency F3. Further, the distance traveled by objects 204″ inside chamber 202″ is shown by an arrow adjacent to “F3.” As a result, applying frequency F3 displaces objects 204′″ to a location closer to center region 208″.

It is important to note that in FIG. 2C, before objects 204″ are propelled, they are located at or near antinode 246″ associated with frequency F3, which is proximate or the same as zero pressure node 224″ associated with frequency F2. Upon an immediate application of frequency F3, and immediately after generation of frequency F2 has ceased, objects 204″ do not locate from antinode 246″ to a zero pressure node 248″ (to satisfy the downhill trajectory). Rather, the present teachings believe that radiation forces resulting from the acoustic energy and inertial forces produced from a momentum, which propelled objects 204″ from antinode 242″ to 224″ (i.e., along the distance associated with “F1”), propels objects 204″ to move to zero pressure node 226′″ associated with frequency F3. Consequently, objects 204″ initially acquire a position of higher pressure by arriving at a location of a high pressure node, and then settle to a lower pressure state when they arrive at a location of zero pressure node 226″. According to FIG. 2C, objects 204,″ do not always travel along a downhill pressure profile, as they did in FIGS. 2A and 2B. Thus, the present teachings recognize that ceasing one frequency, and applying another frequency immediately thereafter, provides particles with sufficient kinetic energy to move forward even though that path requires traveling through a high pressure hump (as denoted by presence of high pressure node 246″).

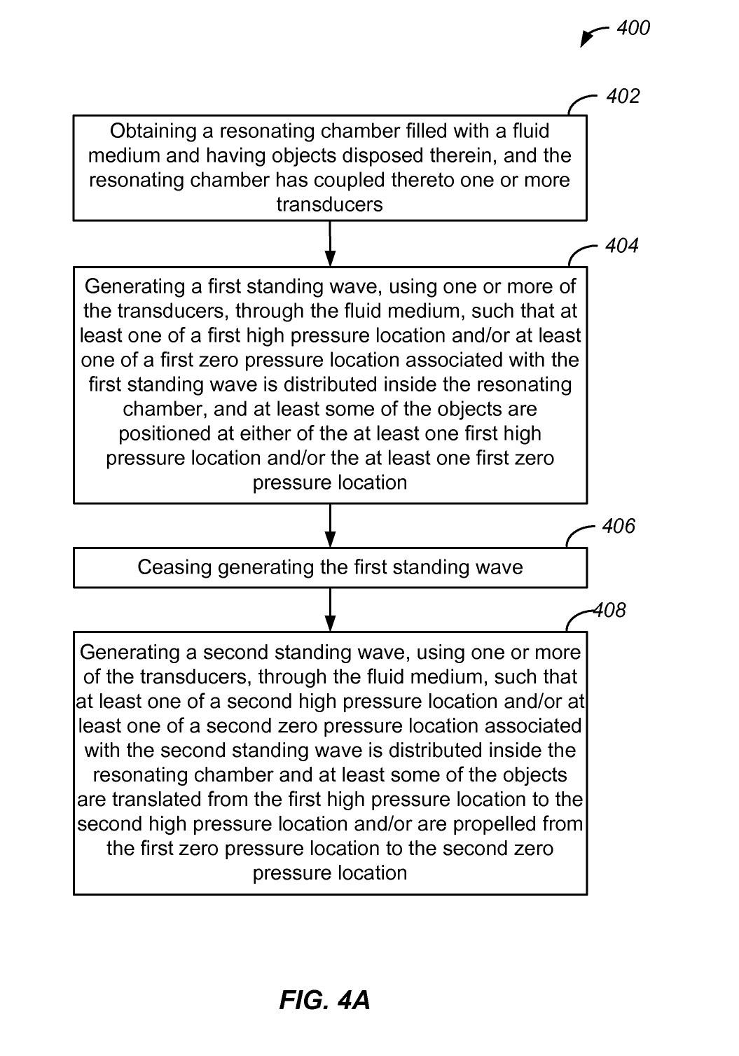

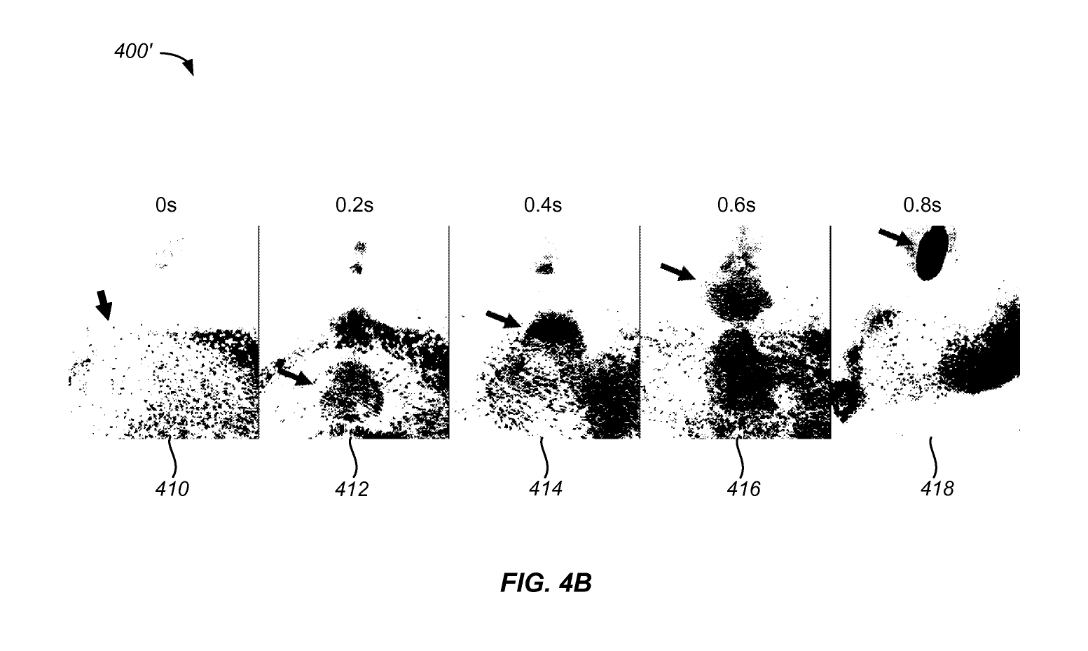

FIG. 2D shows a yet another profile 200′″, according to one embodiment of the present arrangements, of standing waves 214′″, 216′″, 218′″, 220′″, 222′″, 252′″, and 254′″, inside a chamber 202′″. Objects 204′″, chamber 202′″, acoustic transducers 206′″, a port 210′″, a center region 208′″, a bottom region 212′″, standing wave 214′″ with a zero pressure node 242″, standing wave 216′″ with a zero pressure node 224′″, and standing wave 218′″ with a zero pressure node 226′″, as well as the x-axis and y-axis shown on FIG. 2D, are the same as or substantially similar to their counterparts in FIGS. 2A, 2B, and 2C. Standing wave 220′″, generated by a frequency F4, includes a zero pressure node 228′″, and standing wave 254′″, generated by a frequency F6, includes a zero pressure node 240′″. According to the embodiment of FIG. 4D, frequencies F4 and F6 are substantially similar, and therefore, waves 220′″ and 254′″ may be thought of as substantially similar waves that are generated at different instances in time. In other words, frequency F4 and F6 are similar, but frequency F4 is generated before frequency F6. Likewise, frequency F5, which generates standing wave 252′″ with a zero pressure node 230′″, is substantially similar to frequency F1, which generates standing wave 214′″. Accordingly, standings waves 214′″ and 252′″ may be thought of as substantially similar waves generated at different instances in time. Standing wave 222′″, which is generated at non-spherical mode frequency F7, includes a zero pressure node 242′″ disposed at or near center region 208′″.

Regardless of any similarities and/or differences among the different frequencies, by sequentially applying different or even same frequencies, objects may be propelled from a bottom region to a center region of chamber 202. The incremental distances traveled by objects 204′″, to zero pressure node 242′″, are shown by the arrows adjacent to each of the labels showing frequencies F1-F7. The pressure profiles realized during movement of objects 204′″ from a bottom region 212′″ to zero pressure node 240′″ of wave 220′″, are shown by the bolded regions of standing waves 214′″ (F1), 216′″ (F2), 218′″ (F3), 220′″ (F4), 252′″ (F5), and 254′″ (F6), on FIG. 2D. Location of zero pressure node 240′″ of wave 220′″ generated by frequency F6 is the same or substantially similar to that of an antinode 256′″ of wave 222′″ generated by frequency F7.

Upon application of a frequency F7, objects 204′″ move from location 256′″ to a location 242′″ of standing wave 222″. Location 242′″ is at or near center region 208″. As a result, standing wave 222′″ is referred to as a “centering wave” because it conveys objects 204′″ to at or near center region 208″. Centering wave 222′″ may be selected from a range of non-spherical modes to position objects 204′″ at or near a location of zero pressure node 242′″, which in turn is at or near center region 208″.

According to preferred embodiments of the present arrangements, objects 204′″ positioned at or near center region 208′″ are levitated for treatment or processing, e.g., including applying one or more cavitation cycles.

FIGS. 2A-2D explain movement of objects that are relative more dense than the fluid medium inside a resonating chamber. However, the present teachings also similarly contemplate movement of objects that are relatively less dense than the fluid medium inside the resonating chamber. In certain aspects of the present teachings, frequency F7 may not be non-spherical, but may rather be a spherical mode frequency. In other words, centering wave need not be generated by a spherical mode frequency, but a non-spherical mode frequency may represent a preferred embodiment of the present teachings. Further, in certain embodiments of the present teachings, one or more of frequencies F1 to F6 may be non-spherical, and the remaining frequencies may be spherical. Regardless of the density of the objects relative to the fluid medium, the present teachings provide use of spherical and non-spherical frequencies to move objects from one location to another predetermined or desired location. As explained below, in certain embodiments of the present teachings, the desired location is a cavitation zone, where the objects are subjected to a cavitating wave.

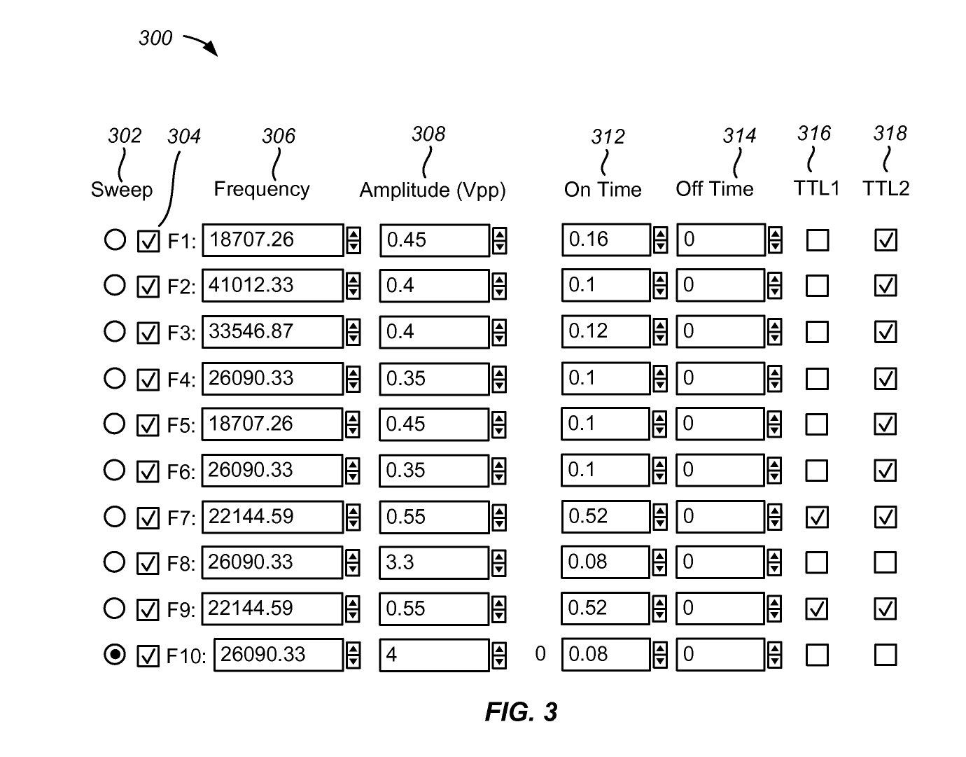

FIG. 3 shows a computer screen display 300, according to one embodiment of the present arrangements, used in generating frequencies F1 to F7 as discussed with respect to FIGS. 2A-2D. As discussed below, frequencies F8 to F10 facilitate centering and cavitation of objects (e.g., objects 204′″ of FIG. 2D).

Display 300 shows inputs of one or more parameters associated with generating acoustic standing waves that translate, levitate, and/or process (e.g., by cavitation) objects inside a fluid-filled, resonating chamber (e.g., chamber 102 of FIG. 1). To this end, computer screen display 300 shows sweep buttons 302, frequency boxes 304, frequency settings 306 (identifying frequencies F1-F10), amplitude settings 308, on time settings 312, off time settings 314, TTL1 (transistor-transistor logic 1) boxes 316, and TTL2 (transistor-transistor logic 2) boxes 318.

Frequency settings 306 show frequency values (presented in values of Hz), frequencies F1-F7, as shown in FIG. 2D, which translate objects from bottom region 212 of FIG. 2A to a center region 208′″ of FIG. 2D, are shown under frequency settings 306. Frequency F8 generates a cavitating wave as it cavitates the objects for a first time when they are located at a cavitation zone, e.g., at or near or near a center region (e.g., center region 208′″ of FIG. 2D). Frequency F9 generates a centering wave that centers objects back to the cavitation zone after being dispersed by the previous cavitation frequency. Next, Frequency F10 generates a second cavitating wave that cavitates the objects at or near the center region for a second time. Frequencies F9 and F10, generated in sequence, and/or frequencies F7 and F8, generated in sequence, may be repeated any number of times to repeat cycles of cavitation and centering of objects. In this manner, the present teachings provide one or more cycles of cavitation and centering of objects until the objects are transformed from one state to another. In other words, the present teachings recognize that due to limitations in the amount of objects than can be propelled to and/or cavitated at a center region of a resonator at one time, multiple cycles of propelling and/or cavitating objects may be required.

Amplitude settings 308 shows amplitude values, according to one embodiment of the present arrangements, associated with frequencies F1-F10. In particular, FIG. 3 shows the “Vpp,” or “peak-to-peak” voltage used to generate a standing wave of a particular amplitude. The present teachings recognize that while the frequency of a wave does not change due to changes in amplitude, standing waves that are generated by relatively higher amplitude values produce higher pressure values associated with the acoustic fields of the standings waves. The present teachings also recognize that a prolonged lapse in time between generating two successive frequencies may cause objects, collected at a particular location, to disperse in the fluid medium. Higher amplitude values of a standing wave may reduce such dispersion of objects and allow greater control over their movement. Further, relatively higher amplitude may facilitate translation of relatively large and/or relatively larger amounts of object to a desired location or zone in a resonating chamber. From amplitude setting values provided in the embodiment shown in FIG. 3, it is observed that frequencies that produce cavitating waves are much higher than those that produce translational waves. By way of example, FIG. 3 shows cavitating waves generated with amplitude values of 3.3 and 4 (e.g., associated with frequencies F8 and F10, respectively), that may be between about 6 and about 12 times greater than the amplitudes for translational waved generated by frequencies F1 to F7 and F9.

The present teachings recognize that pressure amplitudes achieved in a resonating chamber may be restricted by various energy-loss mechanisms that cause attenuation of acoustic waves. By way of example, during cavitation, cavitation bubbles absorb acoustic energy, limiting the maximum pressure amplitudes that may be achieved in the resonating chamber during generation of standing waves. This may create problems during translating and/or levitating objects in the spherical resonator if the acoustic radiation forces produced by the subsequent standing waves are insufficient to overcome other forces (e.g., gravity, buoyancy, and drag forces) acting on the objects. To this end, in certain embodiments of the present teachings, a fluid medium that does not promote cavitation or suppresses cavitation inside the resonating chamber (e.g., oils) is used during subsequent generation of standing waves used to translate and/or levitate objects. In certain other embodiments of the present teachings, however, increasing a static pressure inside of the fluid medium inside a resonating chamber is carried out to suppress cavitation, because cavitation will not occur until the acoustic pressure amplitude is greater than the static pressure. Therefore, increasing the static pressure considerably extends achievable amplitudes of standing waves, producing acoustic radiation forces sufficient to overcome other forces acting on the objects to allow translation and/or levitation.

On time settings 312 show a time duration (in seconds), during which a particular frequency is being generated. Off time settings 314 show a time duration (in seconds), during which generation of particular frequency ceases and the subsequent frequency is generated. As shown in the embodiment of FIG. 3, off time settings are being set at “0” (i.e., lapse of zero seconds between two frequencies). In other words, as soon as generation of a particular frequency stops, a subsequent frequency is immediately generated without any lapse of time. According to the present teachings, because little or no gap in time is allowed between the presence of sequential frequencies, objects being propelled from location to location may gain inertia and, therefore, may rapidly move to a desired or predetermined location.

Sweep buttons 202 of FIG. 3 include boxes that are checked to select when a “sweep” is to be carried out after a particular resonant frequency is generated. Sweep buttons 202 may be thought of as initiating a quality control method for assuring that a standing wave with an optimum resonance is being generated inside the chamber. The present teachings recognize that speed of sound inside a fluid medium may change over a period of time due to different reasons, e.g., change in ambient temperature of a resonator system and increasing temperature and pressure conditions caused by generating multiple acoustic standing waves. To this end, when a sweep is requested (by checking the box associated with sweep buttons 202), the transducers generate multiple frequencies in the vicinity of an expected frequency to identify a frequency that produces an optimum resonance based on the conditions of the resonating chamber at that time.

Approximate values of resonant frequencies (e.g., frequencies F1-F7, shown associated with frequency values 306 in FIG. 3) may be calculated using a ratio of sound speed of a fluid medium inside a resonating chamber to the diameter of the resonating chamber. Using these approximate values, the precise values of resonant frequencies may be determined According to one embodiment of the present teachings, a frequency “sweep,” showing a response of the resonant system at each of the different frequencies, in the vicinity of the expected frequency, is carried out. In other words, if an expected value of a resonant frequency is known, a sweep is carried out at multiple frequencies that have values that are relatively close to the expected value of the resonant frequency. To this end, sweep buttons 202 show boxes that are checked to select an expected frequency, in the vicinity of which a frequency “sweep” is to be carried out (e.g., frequency F10 in FIG. 3). Such a sweep is preferably carried out at predetermined intervals to adjust resonant frequencies during operation of a resonator system. In alternate embodiments of the present arrangements, however, changes in pressure and temperature inside resonating chamber are measured and received by a computer, which may adjust frequency settings to account for those changes.

Another method to determine the precise values of resonant frequencies is to use a Fast Fourier Transform (FFT). The FFT shows the response of the resonant system to various frequencies that may be excited, for example, by a pulse. Alternatively, the FFT may be measured immediately after the transducer is turned off. When the transducer is turned off, the resonant system may continue to “ring,” and the frequency spectrum of the ringing signal may provide exact values of the resonant frequencies for the resonance system. As the present teachings propose, switching transducer of the resonating chambers on and off (e.g., during translation, levitation, and treatment).

When a box 316 under the heading “TTL1” is checked, the control system (e.g., control system 114 of FIG. 1) determines whether a desired amount of objects are present at a particular node location (i.e., zero pressure node location or high pressure antinode location or at a particular zone, e.g., a cavitation zone). According to one embodiment of the present teachings, a TTL1 check is implemented when an acoustic pulse is delivered to a region (e.g., node location) where objects are located. A resulting pulse echo, which bounces back after striking the objects, is received and measured to determine the amount of objects present at the location.

This determination may be deemed important before a subsequent frequency is generated. If it is determined that sufficient amount of objects are not present at a node location, then instead of proceeding to a next frequency value, either the translation process may be stopped or may proceed to the beginning (e.g., generates frequency F1, as shown in FIG. 2A), or to an intermediate stage (e.g., generates frequency F3, as shown in FIG. 2), to gather more objects for translation and/or processing. If it is determined that a greater amount, than required, of the objects are present, then the amplitude setting may be lowered to reduce the amount of objects that translate to a next location and/or undergo treatment, such as cavitation.

The present teaching recognize that prior to any treatment such as cavitation, it may be important to make sure that the requisite amount of objects are present at a treatment zone where the objects are undergoing treatment. By way of example, after frequencies F1 to F7 have translated and positioned objects at a treatment zone, e.g., center region 208′″ of FIG. 2D, a TTL1 check may be performed to ensure that a sufficient amount of objects are present to undergo treatment.

TTL2 boxes 318 may be used to control a relay that disconnects selected transducers. By way of example, the use of certain transducers may be experimentally determined to increase the amount of objects propelled to a treatment zone inside a resonator chamber. By identifying the appropriate transducers that need to be turned off in the boxes 318 (under the “TTL2” heading), a desired standing wave is generated. In FIG. 3, TTL2 turns off a predetermined transducer or set of transducers.

The various parameter settings shown in FIG. 3 are not essential to the present teachings. Rather, such details are provided to illustrate that certain features may be implemented to recognize the different attributes of the present teachings.

FIG. 4A shows a flowchart of a process 400, according to one preferred embodiments of the present arrangements, for propelling objects to a location in a resonating chamber (e.g., a center region of a resonating chamber). Process 400 begins with a step 402, which includes obtaining a resonating chamber (e.g., resonating chamber 102 of FIG. 1) filled with a fluid medium and having objects (e.g., objects 202 of FIG. 2A) disposed therein. The resonating chamber has coupled thereto one or more transducers (e.g., transducer 106 of FIG. 1).

Next, a step 404 includes generating a first standing wave, using one or more of the transducers, through the fluid medium, such that at least one of a first high pressure location and/or at least one of a first zero pressure location associated with the first standing wave is distributed inside the resonating chamber. In the presence of the standing wave, at least some of the objects disposed inside the resonating chamber are displaced to the first high pressure antinode location and/or to the first zero pressure node location. By way of example, FIG. 2A shows objects 104 (e.g., graphite particles), under the influence of a resonating frequency F1, are positioned at a first zero pressure location 242.

Next, a step 406 includes ceasing generation of the first standing wave. In other words, in this step, the resonating frequency that produces the first standing wave is turned off.

Next, a step 408 includes generating a second standing wave, using one or more of the acoustic drivers, through the fluid medium, such that at least one of a second high pressure location and/or at least one of a second zero pressure location associated with the second standing wave is distributed inside the resonator. Under the influence of the second standing wave, at least some of the objects are propelled from the first high pressure location to the second high pressure location and/or are propelled from the first zero pressure location to the second zero pressure location. Although not necessarily, but preferably, step 408 is initiated immediately after step 406 is completed. As explained above with reference to FIG. 2C, by generating the second standing wave immediately after ceasing generation of the first standing wave, the objects may be easily propelled toward a different location by virtue of the additional inertial forces retained by the objects.

FIG. 4B is a series of frames from a video 400′ further illustrating displacement (as described in FIG. 4A) of objects, such as graphite particles, from one location to another. In the example of FIG. 4B, the graphite particles undergo translational movement from a bottom region to a center region of a water-filled spherical resonator chamber in a manner that is consistent with the teachings of FIG. 2A-2D. Specifically, movement of objects from a bottom region to a center region is realized by generating four resonating frequencies in 0.8 seconds. In certain embodiments of the present teachings, a center region is a treatment zone.

Frame 410 shows graphite particles (adjacent to the black arrow) sitting at a bottom region of a resonating chamber (e.g., resonating chamber 102 of FIG. 1), when time, t, equals zero (0) seconds. In other words, frame 410 shows graphite particles before a first standing wave is generated.

Frame 412 shows that under the influence of a first standing wave at time, t, equals 0.2 seconds, some of the same graphite particles accumulate in a generally sphere-like configuration at a zero pressure location associated with the first standing wave. Further, due to forces of gravity that may be acting upon the objects, distribution of the objects is non-uniform in the generally sphere-like configuration. The first standing wave is generated by a first spherical mode, which arranges the objects in a sphere-like configuration inside the resonating chamber.

Frame 414 shows that under the influence of a second standing wave (produced by another spherical mode frequency) at time, t, equals 0.4 seconds, some of the graphite particles shown in Frame 414 accumulate in a generally sphere-like configuration at a zero pressure location, closer to the center region of the resonating chamber, associated with the second standing wave.

Frame 416 shows that under the influence of a third standing wave (produced by another spherical mode) at time, t, equals 0.6 seconds, some of the graphite particles shown in Frame 416 accumulate in a generally sphere-like configuration at a zero pressure location associated with the third standing wave. Frames 412, 414, and 416 show that as the cluster of graphite particles (hereinafter “graphite cluster”) is propelled closer to the center region of the resonating chamber, the density of the graphite cluster increases, but the size of the graphite cluster decreases.

Frame 418 shows that under the influence of a fourth standing wave (produced by a non-spherical mode) at a time, t, equals 0.8 seconds, some of the graphite particles shown in Frame 416 accumulate in a generally disk-like formation at a zero pressure location that is at or near the center region of the resonating chamber. As explained above with reference to FIG. 2D, a centering wave generated by a non-spherical mode may position objects at or near the center region of the resonating chamber.

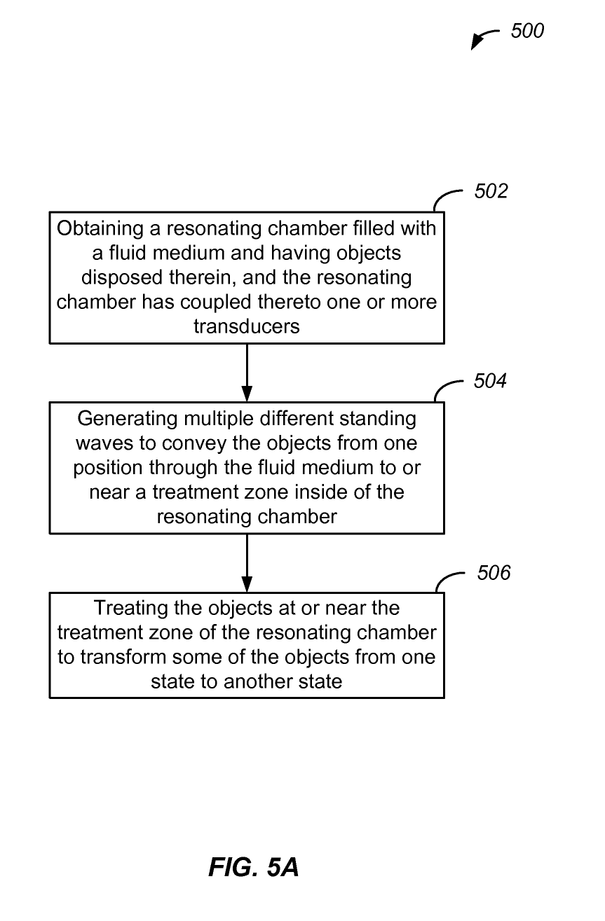

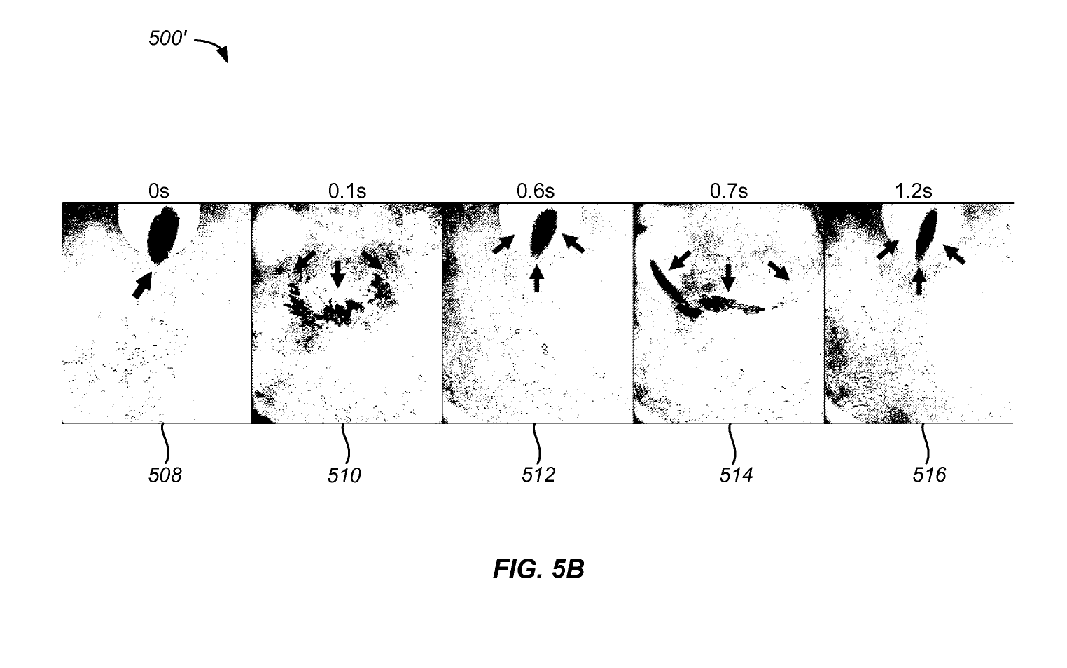

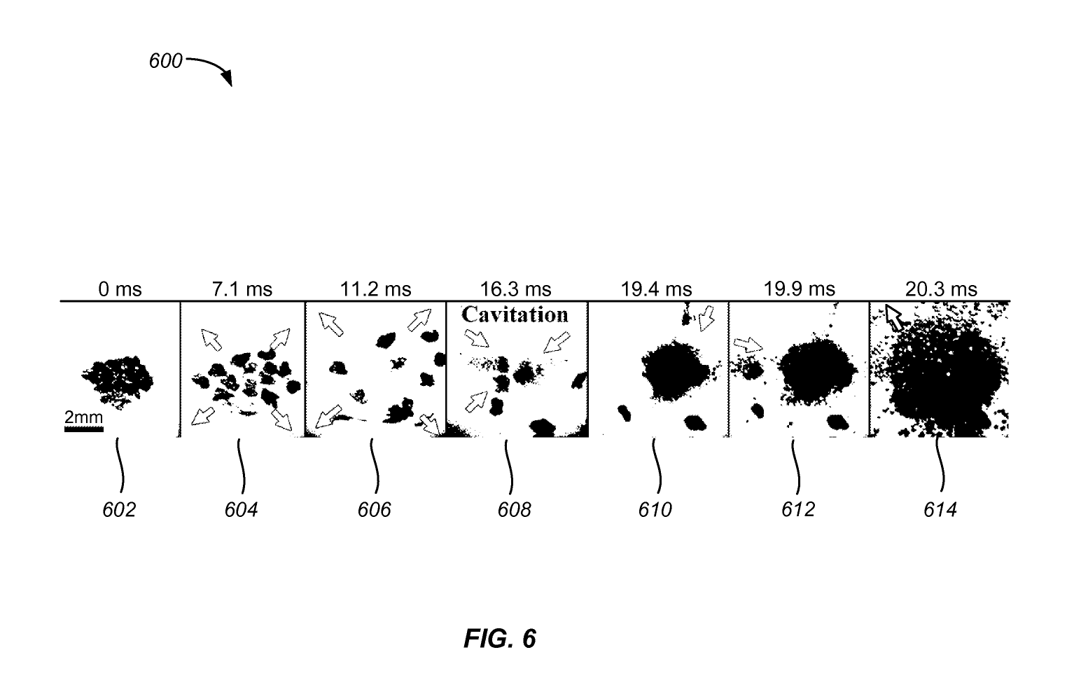

FIG. 5A shows a flowchart for a process 500, according to one preferred embodiment of the present arrangements, for treating objects in a resonating chamber. Process 500 begins with a step 502, which includes obtaining a resonating chamber filled with a fluid medium and having objects disposed therein. The resonating chamber may be coupled to one or more transducers, which generate, inside the chamber, required frequencies to produce one or more standing waves (e.g., standing waves shown in FIG. 2D). Step 502 may be carried out in a manner that is substantially similar to step 402 of FIG. 4A.

Next, a step 504 includes generating multiple different standing waves to allow translational movement of objects from one location in the fluid medium to another location (e.g., a treatment zone) that may be located at or near a center region of the resonating chamber. Step 504 may be carried out in a manner that is substantially similar to steps 404-408 of FIG. 4A. It is important to note that the present teachings recognize that multiple different standing waves may not be necessary to move objects from one location to another, and that in certain aspects of the present teachings, a single standing wave may accomplish that goal. The present teachings also recognize that steps 502 and 504 may not be required to displace objects, and other methods may well be used. In such embodiments of the present teachings, objects inside a fluid-filled resonating chamber are subject to a treatment wave, as described below.

Next, a step 506 includes cavitating the objects to convert some of the objects from one state to another state. By way of example, Frame 418 of FIG. 4B shows that graphite particles, accumulated in a disk-like configuration at or near the center region of the resonator, undergo cavitation under the influence of a cavitation wave. In another type of treatment is required, then this step may include translating objects using a treating wave to a treatment zone so that the appropriate type of treatment is effected there.

FIG. 5B shows a series of frames from a video 500′, according to one embodiment of the present arrangements, showing graphite particles at a cavitation zone inside a resonating chamber and subject to two cycles of cavitation (with two cavitating waves) over a period of 1.2 seconds.

Frame 508 shows a disk of graphite particles at time, t, equals zero (0) seconds, i.e., at a cavitation zone. Frame 510 shows at time, t, equals 0.1 seconds and under the influence of high pressures created from a cavitating wave, graphite particles scattering away from the cavitation zone, and hence scattering away from their accumulated disk configuration.

Frame 512 shows, at time, t, equals 0.6 seconds and under the influence of a positioning wave (which may be called a “centering wave” when it positions the objects at or near a center region of the resonating chamber), some of the scattered graphite particles from Frame 510 moving back to the cavitation zone and reforming into a graphite disk. In certain embodiments of the present teachings, the graphite disk of Frame 506′ includes relatively fewer graphite particles than the graphite disk of Frame 508. In other words, not all graphite particles that were subject to the cavitating wave in Frame 510 return to the cavitation zone under the influence of a positioning wave.

Next, Frame 514, which is substantially similar to Frame 510, shows that cavitation is carried out at time, t, equals 0.7 seconds. In Frame 514, the reformed graphite disk of Frame 512 undergoes cavitation under the influence of a cavitating wave.

Frame 516, which is substantially similar to Frame 512, shows that some of the scattered graphite particles shown in Frame 514, under the influence of positioning wave, return back to the cavitation zone. In this manner, multiple cycles of cavitating and positioning waves may be generated such that a sufficient number of objects, such as graphite particles, may be transformed from one state to another.

FIG. 600 depicts a series of frames from a video 600, according to one embodiment of the present arrangements, taken from a high-speed camera and showing particles under the influence of a cavitating wave.

Frame 602 shows a graphite disk formed at a cavitation zone at time, t, equals zero (0) seconds. Frames 604 and 606 show, at time, t, equals 7.1 milliseconds and 11.2 milliseconds, respectively, that under the influence of a cavitating wave, graphite particles are driven to the edge of or, in some instances, out of the cavitation zone. According to the present teachings, cavitation may not occur at the cavitation zone until an appropriate amount of time has lapsed to generate sufficiently high pressures. To this end, frames 604 and 606 show the formation of a high pressure location at the cavitation zone, prior to cavitation, that drives away the graphite particles present in that zone.

Frame 608 shows formation of cavitation bubbles (from the presence of the fluid medium at the cavitation zone) at time, t, equals 16.3 milliseconds, resulting from the influence of a cavitating wave, and particularly from the high pressure produced at the cavitation zone. By way of example, if the cavitation zone is at or near the center of the resonating chamber, then cavitating bubbles are formed at or near the center of the resonating chamber, where the acoustic field is strongest. According to the present invention, the cavitation bubbles are attracted to the interfacial boundary between the graphite particles and the fluid medium. Consequently, Frame 608 shows that the cavitation bubbles carry the graphite particles along with them towards the cavitation zone.

Frames 610 and 612, at time, t, equals 19.4 milliseconds and 19.9 milliseconds, respectively, and after cavitation is effected. According to these frames, graphite particles during this period of time accumulate at the cavitation zone, as more and more of the cavitation bubbles carry the graphite particles there.

Frame 614, at time, t, equals 20.3 milliseconds after a cavitating wave is applied, shows graphite particles moving away from the cavitation zone by the action of the imploding cavitation bubbles. In the case of relatively dense graphite particles, such particles move from the cavitation zone toward adjacent zero pressure locations. Accordingly, if another cycle of cavitation is desired, a positioning wave (as explained above with reference to Frame 506′) is generated to position graphite particles back at the cavitation zone.

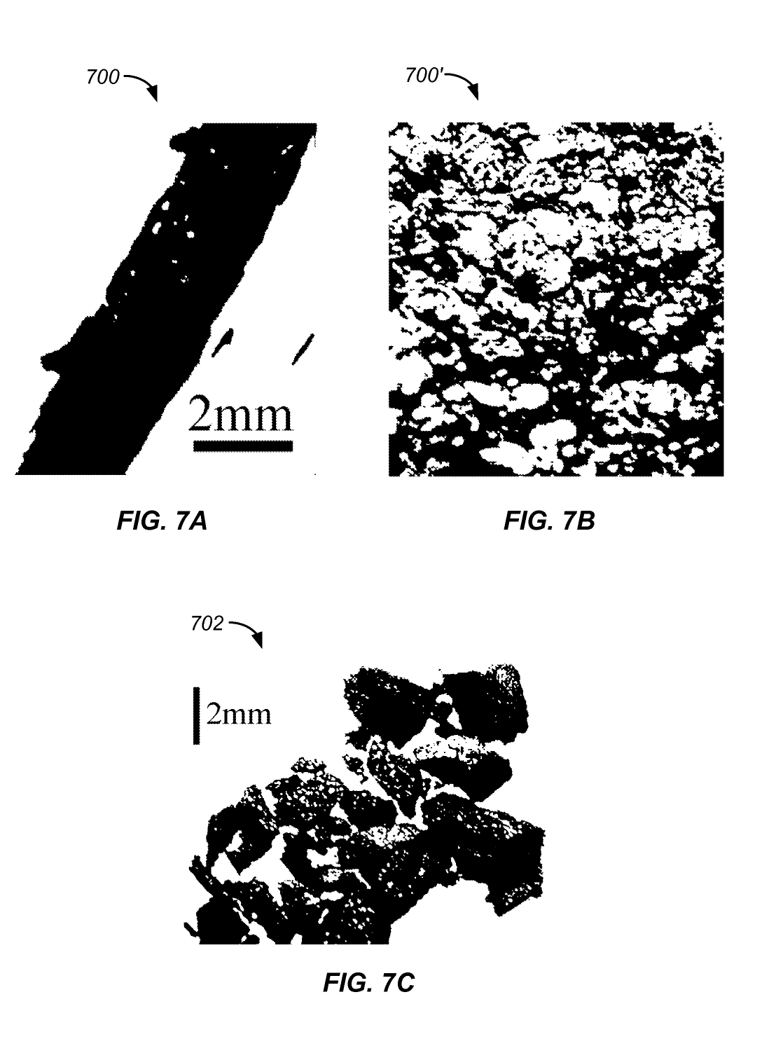

FIG. 7A is a picture 700 of a side view of a graphite disk, i.e., in which the graphite particles are arranged in a disk-like configuration, that levitates at a cavitation zone, e.g., a center region of a spherical resonating chamber. The graphite disk has a diameter that is generally between about 1.0 cm and about 2 cm. In other embodiments of the present teachings, the diameter of the graphite disk is approximately a distance from the high pressure antinode location to the zero pressure node location associated with the centering wave (e.g., standing wave 222′″ of FIG. 2D). FIG. 7B is a picture 700′ of a front view of the graphite disk shown in FIG. 7A.

FIG. 7C is a picture 702 of a side view of graphite chunks in a graphite disk, according to certain embodiments of the present arrangements, levitated at a cavitation zone. The graphite chunks shown in the embodiment of FIG. 7C are relatively larger than the graphite flakes shown in FIGS. 7A and 7B, ranging in size from about 0.01 mm to several millimeters. Accordingly, the present teachings may be used to levitate and cavitate objects of varying sizes.

Although illustrative embodiments of this invention have been shown and described, other modifications, changes, and substitutions are intended. By way of example, although described embodiments refer to performing cavitation at a cavitation zone, the present teachings are not so limited. In fact, cavitation is only described as an example of treatment. To this end, the present teachings contemplate a treatment zone, where the objects may be first positioned and then undergo any type of treatment. Accordingly, it is appropriate that the appended claims be construed broadly and in a manner consistent with the scope of the disclosure, as set forth in the following claims.

What is claimed is:

1. A process for translating objects in a resonating chamber, comprising:
obtaining a resonating chamber filled with a fluid medium and having objects disposed therein, and said resonating chamber having coupled thereto one or more transducers;
generating a first standing wave, using one or more of said transducers, through said fluid medium, such that at least one of a first high pressure location and/or at least one of a first zero pressure location associated with said first standing wave is distributed inside said resonating chamber, and at least some of said objects are positioned at either of said at least one first high pressure location and/or said at least one first zero pressure location;
ceasing said generating said first standing wave;
generating a second standing wave, using one or more of said transducers, through said fluid medium, such that at least one of a second high pressure location and/or at least one of a second zero pressure location associated with said second standing wave is distributed inside said resonating chamber, and at least some of said objects are translated from said first high pressure location to said second high pressure location and/or are translated from said first zero pressure location to said second zero pressure location.

2. The process of claim 1, wherein said first high pressure location includes a location within said resonating chamber that is occupied by a first high pressure antinode obtained from said generating said first standing wave, said first zero pressure location includes a location within said resonating chamber that is occupied by a first zero pressure node obtained from said generating said first standing wave, said second high pressure location includes a location within said resonating chamber that is occupied by a second high pressure antinode obtained from said generating said second standing wave, and said second zero pressure location includes a location within said resonating chamber that is occupied by a second zero pressure node obtained from said generating said second standing wave, and during said generating said first standing wave or said generating said second standing wave, said objects that are less dense than said fluid medium accumulate at said first high pressure antinode and/or said second high pressure antinode, and said objects that are more dense than said fluid medium accumulate at said first zero pressure node and/or at second zero pressure node.

3. The process of claim 1, wherein said generating said first standing wave includes generating a translating wave and said generating said second wave includes generating a centering wave, said generating said translating wave is carried out prior to said generating said centering wave, said generating said translating wave causes at least some of said objects to be translated to said first high pressure locations or said first zero pressure locations that are a distance away from a center region of said resonating chamber, and wherein said generating said centering waves causes said second high pressure locations or said second zero pressure locations to be disposed at or near said center region of said resonating chamber, and causes at least some of said objects to be translated from said first high pressure location or said first zero pressure location to a location at or near said center region of said resonating chamber.

4. The process of claim 3, wherein said generating said centering waive is carried out at a resonant frequency such that said second zero pressure locations and said second high pressure locations are not spherically aligned inside said resonating chamber.

5. The process of claim 3, wherein during said generating said centering wave, at least some of said objects accumulate in a disk-like formation at or near said center region of said resonating chamber.

6. The process of claim 1, wherein said generating said first standing wave is produced in a spherical mode at a resonant frequency such that said first zero pressure locations and said first high pressure locations are spherically aligned inside said resonating chamber and said generating said second standing wave is produced in a non-spherical mode at another resonant frequency such that said second zero pressure locations and said second high pressure locations are not spherically aligned inside said resonating chamber.

7. The process of claim 1, wherein prior to said generating a first standing wave, said objects are resting on a bottom region of said resonating chamber and prior to said ceasing said generating said first standing wave, at least some of said objects are levitating at a high pressure location or at a zero pressure location associated with said first standing wave.

8. The process of claim 1, wherein said second high pressure location is closer in distance to said center region of said resonating chamber than said first high pressure location, and/or said second zero pressure location is closer in distance to said center region of said resonating chamber than said first zero pressure location.

9. The process of claim 1, wherein prior to said generating a first standing wave, said objects are disposed at a top region of said resonating chamber and prior to said ceasing said generating said first standing wave, at least some of said objects are levitating at a high pressure location associated with said first standing wave.

10. The process of claim 1, further comprising preventing cavitation from occurring prior to said generating said first standing wave and said generating said second standing wave.

11. The process of claim 10, wherein said preventing includes increasing a static pressure inside a resonating chamber or using fluids that do not promote cavitation.

12. A process for treating objects in a treatment zone inside a resonating chamber, said process comprising:
obtaining a resonating chamber filled with a fluid medium and objects disposed therein;
generating multiple different standing waves to translate said objects from a position inside said resonating chamber, through said fluid medium, to a treatment zone inside said resonating chamber; and
treating said objects at or near said treatment zone of said resonating chamber to transform some of said objects from a first state to a second state.

13. The process of claim 12, wherein said treating includes cavitation, and treatment zone includes a cavitation zone and wherein a last one of said multiple different standing waves is a positioning wave that positions some of said objects at or near said treatment zone.

14. The process of claim 12, wherein said first state includes at least some objects that are not cavitated and said second state includes at least some objects that are cavitated.

15. The process of claim 12, wherein prior to said treating said objects, said generating multiple different standing waves includes generating a centering wave that causes a zero pressure location to be disposed at or near a center region of said resonating chamber and causes said objects to be translated to said center region.

16. The process of claim 12, further comprising, after said treating said objects, generating at least one positioning wave to position said objects, at least some of which are in said first state, at said treatment zone of said resonating chamber.

17. The process of claim 16, wherein said treatment zone is located at or near a center region of said resonating chamber.

18. The process of claim 16, wherein said generating at least one of said positioning wave is produced in a non-spherical mode at a resonant frequency.

19. The process of claim 16, further comprising, after said generating at least one of said positioning wave, treating for a second time some of said objects.

20. The process of claim 12, wherein said generating multiple different standing waves comprises:
generating a first positioning wave through said fluid medium, such that at least one of a first high pressure location and/or at least one of a first zero pressure location associated with said first positioning wave is distributed inside said resonating chamber, and at least some of said objects are positioned at either of said at least one first high pressure location and/or said at least one first zero pressure location;
ceasing said generating a first positioning wave;
generating a second positioning wave through said fluid medium, such that at least one of a second high pressure location and/or at least one of a second zero pressure location associated with said second positioning wave is distributed inside said resonating chamber, at least some of said objects are translated from said at least one of a first high pressure location and/or at least one of a first zero pressure location associated with said first positioning wave to said at least one of a second high pressure location and/or at least one of a second zero pressure location associated with said second positioning wave.

21. The process of claim 12, further comprising performing one or more positioning and treating cycles after said treating, wherein one of said positioning and treating cycles comprises positioning some of said objects to said treatment zone and treating for another time some of said objects.

22. A system for treating objects, said system comprising:
a fluid medium;
a resonating chamber filled with said fluid medium;
objects at a levitated state at or near a cavitation zone of said resonating chamber;
one or more transducers coupled to said resonating chamber wherein said one or more transducers produce a treatment frequency that facilitates treatment of at least some of said objects at said treatment zone to transform at least some of said objects from one state to another state.

23. The system of claim 22, wherein said objects are graphite particles.

24. The system of claim 22, wherein said one state of said objects includes graphite particles and said another state of said objects include diamonds.

25. The system of claim 22, wherein said fluid medium is a cavitating medium and said cavitation zone is located at or near a center region of said resonating chamber.

26. The system of claim 22, wherein said resonating chamber is configured in a shape that is one member selected from a group comprising a sphere, a cube and a cylinder.
